(19) United States
(12) Patent Application Publication
(10) Pub. No.: US 2021/0008821 A1
(43) Pub. Date: Jan. 14, 2021

(54) TRANSFER DEVICE AND TIRE FORMING APPARATUS

(71) Applicant: TOYO TIRE CORPORATION, Itami-shi (JP)

(72) Inventors: Katsuji Niwa, Itami-shi (JP); Hiroyuki Notsu, Itami-shi (JP)

(73) Assignee: TOYO TIRE CORPORATION, Itami-shi (JP)

(21) Appl. No.: 16/910,419

(22) Filed: Jun. 24, 2020

(30) Foreign Application Priority Data
Jul. 12, 2019 (JP) 2019-130567

(51) Int. Cl. B29D 30/26

(52) U.S. Cl. CPC B29D 30/2607; B29D 2030/241

(57) ABSTRACT

To provide a transfer device for transferring a tire constituent member from a first drum to a second drum in a tire forming apparatus. The transfer device includes a main body part having a space for receiving the first drum from one side in an axial direction in a state of being arranged on the same axis as that of the first drum in which the tire constituent member is formed, and a holding device provided so as to hold the tire constituent member from an outer peripheral side in a state where the first drum is arranged in the space. A detection device is installed on an end face on the one side in the axial direction of the main body part and the detection device detects the tire constituent member formed on the first drum during a receiving operation of the first drum into the space.

### CROSS-REFERENCE TO RELATED APPLICATIONS

This application is based upon and claims the benefit of priority from the prior Japanese Patent Application No. 2019-130567, filed on Jul. 12, 2019; the entire contents of which are incorporated herein by reference.

### BACKGROUND

### 1. Field of the Invention

An embodiment of the present invention relates to a tire forming apparatus for forming a green tire and a transfer device that transfers a tire constituent member in the tire forming apparatus.

### 2. Description of Related Art

In a tire forming apparatus used for, for example, manufacture of radial tires for passenger cars, a method for preparing tire constituent members concurrently in division of labor by using a plurality of drums and transfer devices is known.

Specifically, there is a method in which a process of forming a tubular band member including a carcass on a band drum, a process of forming a tubular belt member including a belt on a belt drum, and a process of integrating these members and shaping them into a tire shape are respectively performed in separate stages, and, delivery (namely, transfer) of members between processes is performed by using the transfer devices.

For example, there is disclosed a tire forming apparatus having the band drum, the belt drum and a shaping drum, in which two drums are used as the belt drum in JP-A-2006-116817. In JP-A-2013-220636, there is disclosed a method in which two drums are respectively used as the band drum and the shaping drum. Various layouts have been proposed as described above for shortening waiting time in equipment and improving production efficiency.

An inspection method for measuring dimensions and the like of a tire constituent member by using waiting time and the like of a sticking device of the tire constituent member is proposed in JP-A-2010-101721. Specifically, after the tire constituent member is stuck to a forming drum, a distance to the surface of the tire constituent member is measured by using a laser displacement gauge during waiting time of a machine.

### SUMMARY

In the tire forming apparatus, tire constituent members may be formed concurrently by being assigned to dedicated drums in respective processes and respective tire constituent members may be delivered from the dedicated drums to the shaping drum through the transfer device to be integrated. Accordingly, positional accuracy in respective devices directly affects uniformity of finished tires. That is, dimensions of the tire constituent members formed on drums and positional accuracy on the drums will be important.

However, work efficiency is improved in the tire forming apparatus at the present time, and there is little waiting time. Additionally, the apparatus itself has become complicated and large in size; therefore, it is not desirable to provide a dedicated work station only for inspecting tire constituent members from a viewpoint of area productivity. Accordingly, it is required to inspect tire constituent members with a compact structure without impairing production efficiency.

An embodiment of the present invention has been made in view of the above problems, and an object thereof is to provide a transfer device and a tire forming apparatus including the same capable of inspecting tire constituent members with a compact structure without impairing production efficiency.

A transfer device according to an embodiment of the present invention is a device for transferring a tire constituent member from a first drum for forming the tire constituent member to a second drum for performing a later forming process using the tire constituent member in a tire forming apparatus. The transfer device includes a main body part having a space for receiving the first drum from one side in an axial direction in a state of being arranged on the same axis as that of the first drum in which the tire constituent member is formed on an outer peripheral surface, a holding device provided so as to be able to hold the tire constituent member from an outer peripheral side in a state where the first drum is arranged in the space, and a detection device installed on an end face on the one side in the axial direction of the main body part and detecting the tire constituent member formed on the first drum during a receiving operation of the first drum into the space.

A tire forming apparatus according to an embodiment of the present invention includes the transfer device, a first drum for forming a tire constituent member, and a second drum for performing a later forming process using the tire constituent member transferred by the transfer device.

According to the embodiment of the present invention, the tire constituent member on the first drum can be detected by the detection device during the receiving operation of the first drum by the transfer device at the time of transferring the tire constituent member from the first drum to the second drum. Accordingly, the tire constituent member can be inspected with a compact structure without impairing production efficiency.

### BRIEF DESCRIPTION OF THE DRAWINGS

FIG. 1 is a conceptual diagram of a tire forming apparatus according to an embodiment;

FIG. 2 is a side view showing a cross section (a cross section taken along II-II line in FIG. 3) of a transfer device according to the embodiment, together with a belt drum;

FIG. 3 is a front view of the transfer device (a view seen from an arrow III in FIG. 2);

FIG. 4 is a side view showing a state just before the transfer device receives the belt drum (at the time of starting a measurement by detection devices);

FIG. 5 is a side view showing a stage in the middle of receiving the belt drum by the transfer device (at the time of completing the measurement by the detection devices); and

FIG. 6 is a side view showing a state where the receiving of the belt drum by the transfer device is completed.

### DESCRIPTION OF EMBODIMENTS

Hereinafter, an embodiment of the present invention will be explained with reference to the drawings.

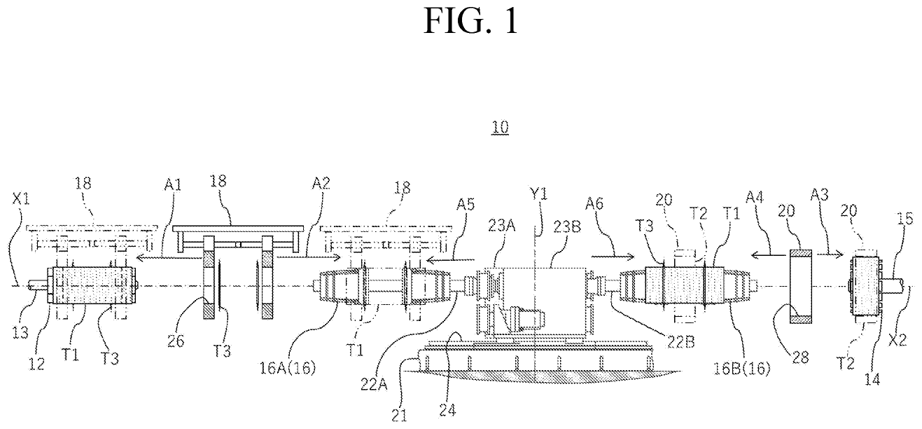

A tire forming apparatus 10 according to an embodiment shown in FIG. 1 is an apparatus for forming an unvulcanized green tire. The tire forming apparatus 10 includes a band drum 12, a belt drum 14, shaping drums 16, a band transfer 18, and a belt transfer 20.

The band drum 12 is a drum for forming a tubular band member T1 arranged on an inner peripheral surface side of the tire, which may adopt a well-known structure.

The band member T1 is a cylindrical tire constituent member including an inner liner and a carcass ply layered on an outer periphery of the inner liner as an example, which may further include other members such as a sidewall rubber and a reinforcing member. Bead members T3 may also be attached as shown in FIG. 1. One carcass ply or plural carcass plies may be provided.

A forming machine for forming the band member T1 on the band drum 12 may adopt a well-known structure, which is not particularly limited. For example, the band drum 12 is supported by a horizontal rotation shaft 13 so as to rotate by a not-shown motor.

Members such as a sheet-shaped inner liner and carcass ply supplied from a not-shown member feeding device are wound around an outer peripheral surface of the band drum 12 to thereby form the band member T1. In detail, it is preferable that the inner liner is wound first and the carcass ply is wound around the outer periphery of the inner liner to form the band member T1.

The belt drum 14 is a drum for forming a tubular belt member T2 arranged on an outer peripheral surface side of the tire, which may adopt a well-known structure.

The belt member T2 is a cylindrical tire constituent member including a belt and a tread rubber layered on an outer periphery of the belt as an example, which may further include other members such as a belt reinforcing layer. The belt is normally formed of a plurality of belt plies, which may include the maximum-width belt ply having the maximum width in a tire width direction and the outermost belt ply arranged on the outermost peripheral side.

A forming machine for forming the belt member T2 on the belt drum 14 may adopt a well-known structure, which is not particularly limited. For example, the belt drum 14 is supported by a horizontal rotation shaft 15 so as to rotate by a not-shown motor.

Members such as a sheet-shaped belt and tread rubber supplied from a not-shown member feeding device are wound around an outer peripheral surface of the belt drum 14 to thereby form the belt member T2. In detail, it is preferable that the belt is wound first and the tread rubber is wound around the outer periphery of the belt to form the belt member T2.

The shaping drum 16 is a drum for forming the band member T1 and the belt member T2 into a tire shape by using these members, which may adopt a well-known structure. In detail, the shaping drum 16 forms a green tire by deforming the band member T1 into a toroidal shape toward outer sides in a radial direction and assembling the band member T1 on an inner peripheral surface of the belt member T2 in a state where the band member T1 is arranged on an outer peripheral surface of the shaping drum 16 and the belt member T2 is arranged so as to surround outer sides in the radial direction of the band member T1.

A forming machine for performing forming into the tire shape in the shaping drum 16 may adopt a well-known structure, which is not particularly limited. For example, it is preferable that the band member T1 is deformed into the toroidal shape by expanding a central portion of the band member T1 by filling the inside of the band member T1 with a compressed gas to apply an internal pressure or using a mechanical expansion device. The shaping drum 16 may include a turning-up mechanism for turning up both end parts of the carcass ply positioned at both end parts in an axial direction of the band member T1 arranged on the outer peripheral surface of the shaping drum 16 so as to wrap the bead members T3. The shaping drum 16 may also include a stitcher for adjusting the shape into the tire shape after the band members T1 is expanded in the radial direction and integrated with the belt members T2.

In this example, two shaping drums 16A and 16B are provided as the shaping drum 16 as shown in FIG. 1. The two shaping drums 16A and 16B are provided so that respective axes X1 and X2 are parallel to each other on a turn stage 21 capable of rotating about a vertical axis Y1. The two shaping drums 16A and 16B are connected and supported so as to rotate at end parts in the axial direction of headstocks 23A and 23B respectively through horizontal rotation shafts 22A and 22B, protruding from the turn stage 21 in directions opposite to each other. The headstocks 23A and 23B are respectively provided so as to travel along a guide rail 24 provided on the turn stage 21, thereby allowing the shaping drums 16A and 16B to advance and retract to member delivery positions along the axes X1 and X2.

The two shaping drums 16A and 16B are arranged between the band drum 12 and the belt drum 14. One shaping drum 16A is arranged on the same axis X1 as that of the band drum 12 in the state shown in FIG. 1 (namely, both axes are on the same straight line X1), and the other shaping drum 16B is arranged on the same axis X2 as that of the belt drum 14 (namely, both axes are on the same straight line X2). When the turn stage 21 turns by 180 degrees, the other shaping drum 16B is arranged on the same axis X1 as that of the band drum 12, and the one shaping drum 16A is arranged on the same axis X2 as that of the belt drum 14.

The band transfer 18 is a transfer device for delivering (namely, transferring) the band member T1 from the band drum 12 to the shaping drum 16, which may adopt a well-known structure.

The band transfer 18 is arranged between the band drum 12 and the shaping drum 16. In this example, the band transfer 18 is arranged on the same axis X1 as that of the band drum 12 in which the band member T1 is formed on the outer peripheral surface, having a space 26 for receiving the band drum 12 from one side in the axial direction. The band transfer 18 is configured to be able to hold the band member T1 from an outer peripheral side of the band member T1 in a state where the band drum 12 is arranged in the space 26. Here, the axial direction of the band transfer 18 indicates a direction parallel to the axis X1.

The band transfer 18 is arranged so as to be able to reciprocate on the axis X1 by a not-shown moving mechanism in this example. The band transfer 18 moves to a position (band receiving position) where the band transfer 18 surrounds an outer periphery of the band drum 12 on a left side as shown by an arrow A1, making a state where the band drum 12 is received in the space 26 and the band drum 12 is inserted thereinto. In this state, a not-shown holding device holds an outer peripheral surface of the band member T1 in the radial direction.

It is also preferable that a pair of bead members T3 are attached to the band transfer 18 in advance so that the pair of bead members T3 are attached to both end parts in the axial direction on the outer peripheral surface of the band member T1 at the time of receiving the band drum 12 into the space 26.

The band transfer 18 is also configured to be able to move to a band delivery position on a right side while holding the band member T1 as shown by an arrow A2. The shaping drum 16 moves to the band delivery position as shown by an arrow A5. Accordingly, the band transfer 18 can move to a position where the band transfer 18 surrounds an outer periphery of the shaping drum 16, thereby arranging the band member T1 so as to surround the outer peripheral surface of the shaping drum 16. When a diameter of the shaping drum 16 is expanded and the holding by the holding device of the band transfer 18 is released in the above state, the band member T1 is delivered to the outer peripheral surface of the shaping drum 16.

The belt transfer 20 is a transfer device for delivering (namely, transferring) the belt member T2 from the belt drum 14 to the shaping drum 16.

In this example, the belt transfer 20 is arranged between the belt drum 14 and the shaping drum 16. The belt transfer 20 is arranged so as to be able to reciprocate along the axis X2 and configured to move to a position (belt receiving position) where the belt transfer 20 surrounds an outer periphery of the belt drum 14 on a right side as shown by an arrow A3. The belt transfer 20 is configured to be able to move to a belt delivery position on a left side while holding the belt member T2 as shown by an arrow A4. The shaping drum 16 moves to the belt delivery position as shown by an arrow A6. Therefore, the belt transfer 20 can move to a position where the belt transfer 20 surrounds the outer periphery of the shaping drum 16.

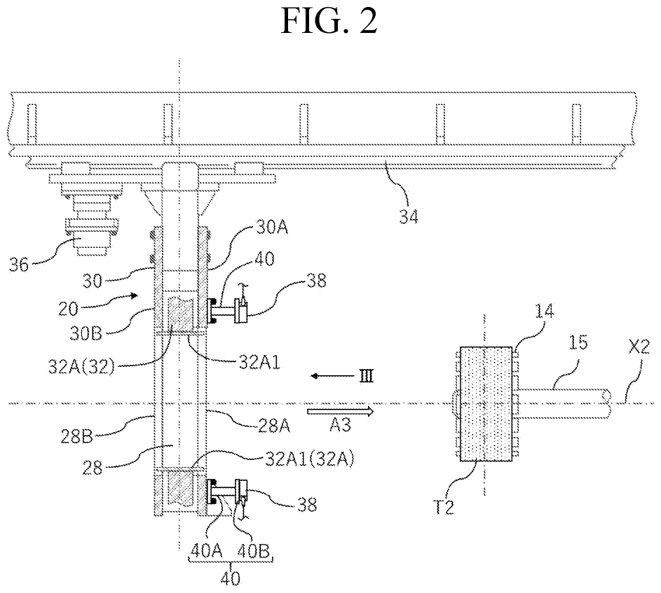

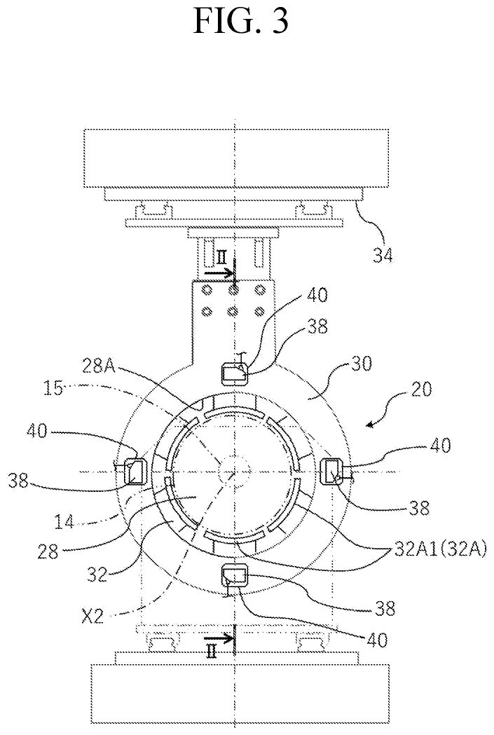

As shown in FIG. 2 and FIG. 3, the belt transfer 20 is arranged on the same axis X2 as that of the belt drum 14, namely, axes of the both members 20 and 14 are on the same straight line X2. The belt transfer 20 includes a main body part 30 having a space 28 for receiving the belt drum 14 from one side in the axial direction in this state and a holding device 32 provided so as to hold the belt member T2 from an outer peripheral side of the belt member T2 in a state where the belt drum 14 is arranged in the space 28. Here, an axis of the belt transfer 20 corresponds to an axis of the tubular holding device 32 holding an outer peripheral surface of the belt member T2 having a tubular shape. An axial direction of the belt transfer 20 or the main body part 30 corresponds a direction parallel to the axis X2.

The main body part 30 of the belt transfer 20 is a frame having a tubular shape (specifically, a short cylindrical shape) with the space 28 as a hollow portion, receiving the belt drum 14 from one side in the axial direction to form a state where the belt drum 14 is arranged in the space 28. In this example, the space 28 is a cylindrical hollow portion, and circular openings 28A and 28B connecting to the space 28 are formed on both end faces 30A and 30B in the axial direction of the main body part 30 (namely, the openings 28A and 28B form both ends of the space 28).

The belt transfer 20 is provided so as to be able to move on the axis X2 by a moving mechanism in this example. Specifically, the main body part 30 is hung so as to travel on a horizontal traveling rail 34 positioned above, moving along the traveling rail 34 by a motor 36. The main body part 30 is thus configured so as to move on the same axis X2 as those of the belt drum 14 and the shaping drum 16, that is, so as to horizontally move in a state where the axis of the main body part 30 corresponds to the axes of the belt drum 14 and the shaping drum 16 on the straight line X2.

The holding device 32 holds the outer peripheral surface of the belt member T2 by a plurality of holding members 32A. Each holding member 32A has a holding piece 32A1 having an arc shape in cross section abutting on the outer peripheral surface of the belt member T2. The holding pieces 32A1 of plural (six in this case) holding members 32A form a cylindrical shape as a whole. Accordingly, the holding device 32 is configured to hold the outer peripheral surface of the belt member T2 by a cylindrical portion that is divided into plural pieces in a circumferential direction.

The holding device 32 is configured to hold the outer peripheral surface of the belt member T2 by respective holding members 32A moving in a diameter reducing direction (inner side in a radial direction) by a not-shown drive means such as motor, and to release the holding of the belt member T2 by respective holding members 32A conversely moving in a diameter expanding direction (outer side in the radial direction).

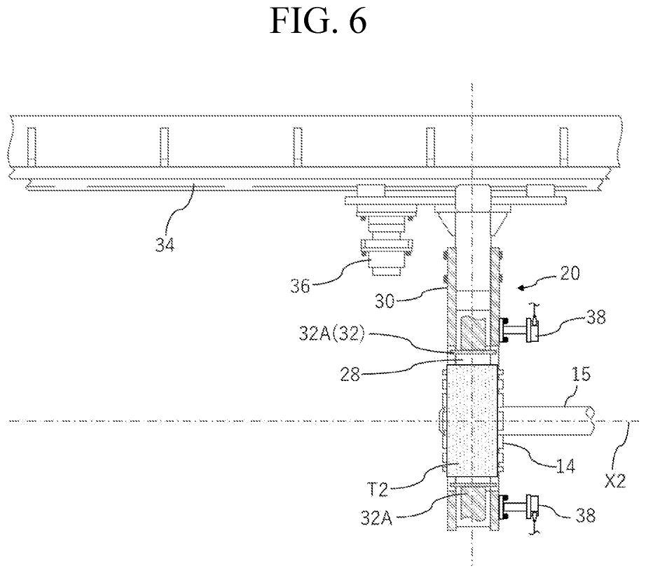

The belt transfer 20 moves to the position where the belt transfer 20 surrounds the outer periphery of the belt drum 14, making a state where the belt drum 14 is received in the space 28 and the belt drum 14 is inserted thereinto as shown in FIG. 6. When respective holding members 32A of the holding device 32 move in the diameter reducing direction in the above state, the outer peripheral surface of the belt member T2 is held in the radial direction.

The belt transfer 20 is also configured to be able to move to the position (belt delivery position) where the belt transfer 20 surrounds the outer periphery of the shaping drum 16 while holding the belt member T2 (see FIG. 1), thereby arranging the belt member T2 so as to surround the outer periphery of the shaping drum 16. After the band member T1 is expanded outward in the radial direction and assembled to an inner peripheral surface of the belt member T2 in the above state, respective holding members 32A of the holding device 32 are moved in the diameter expanding direction, thereby releasing the holding of the belt member T2 and delivering the belt member T2 to the shaping drum 16.

The belt transfer 20 is provided with detection devices 38 for detecting the belt member T2 as shown in FIG. 2. The detection devices 38 are installed on the end face 30A on one side in the axial direction of the main body part 30, detecting the belt member T2 formed on the belt drum 14 during the receiving operation of the belt drum 14 into the space 28.

The detection device 38 detects at least one of a position of the belt member T2 on the belt drum 14 and a dimension in the axial direction of the belt member T2 as an example, preferably detecting both. Specifically, the detection device 38 may detect, as the position of the belt member T2 on the belt drum 14, a position of at least one end of the belt member T2 on the belt drum 14, positions of both ends of the belt member T2 on the belt drum 14, or a position of the center in the axial direction of the belt member T2 on the belt drum 14 by detecting the both ends. When the detection device 38 detects the dimension in the axial direction of the belt member T2, the detection device 38 may detect both ends of the belt member T2 to thereby detect the dimension in the axial direction based on a distance between the both ends.

An optical sensor such as a laser displacement gauge can be used as the detection device 38. However, the detection device 38 is not limited to this, and for example, a line sensor camera and the like may also be used.

The detection devices 38 are attached to the end face 30A on one side in the axial direction of the main body part 30 through stands 40 extending in the axial direction in this example. That is, the stands 40 are provided at a circumferential edge of the opening 28A on the end face 30A on the side where the belt drum 14 is received.

The stand 40 is a member for arranging the detection device 38 at a position apart from the end face 30A in the axial direction, including a columnar portion 40A extending in the axial direction from the end face 30A and a flat-plate shaped installation surface portion 40B provided at a tip end of the columnar portion 40A. The detection device 38 is attached to the installation surface portion 40B of the stand 40.

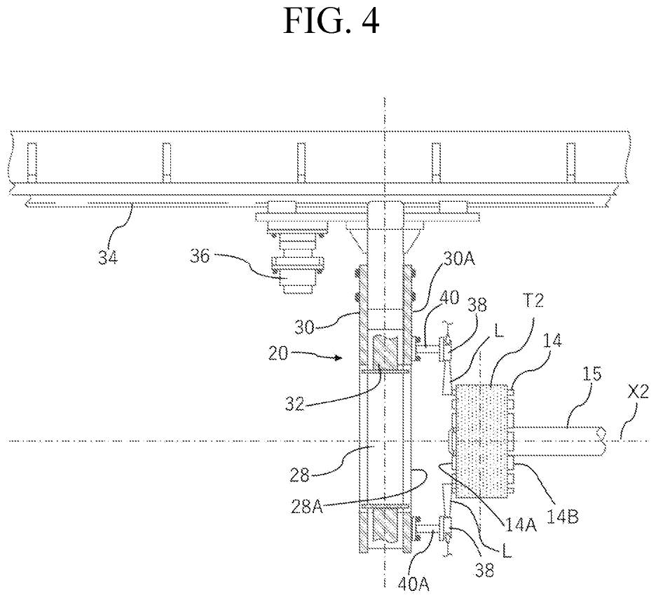

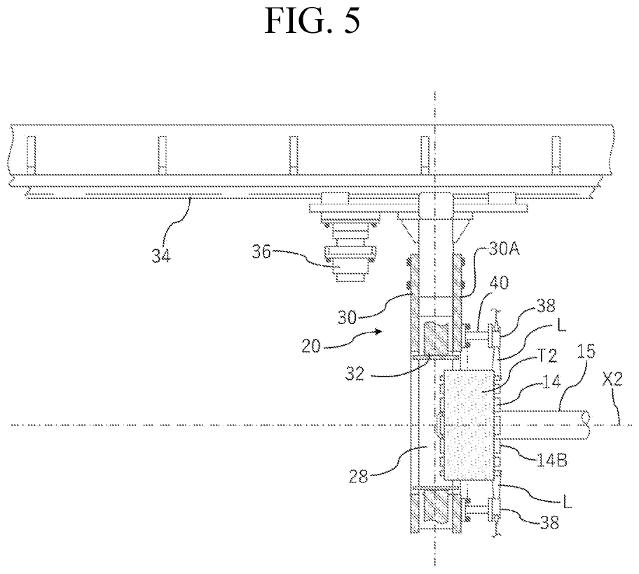

As the detection devices 38 are installed through the stands 40 as described above, the detection devices 38 are configured to carry out a measurement at least in a range from one end (front end) 14A to the other end (rear end) 14B of the belt drum 14 in the axial direction of the belt drum 14 during the receiving operation of the belt drum 14 into the space 28 as shown in FIGS. 4 and 5. That is, a length of the columnar portions 40A of the stands 40 is set so that measurements to the rear end 14B of the belt drum 14 are carried out before the receiving of the belt drum 14 into the space 28 of the main body part 30 is completed. In detail, the detection devices 38 start a measurement at a position in the front of the one end 14A in the axial direction of the belt drum 14 and carry out measurements to a position of the other end 14B in the axial direction, thereby carrying out measurements in a range including the whole length of the belt drum 14.

A plurality of detection devices 38 are provided in this example. The plural detection devices 38 are arranged in a pair or in plural pairs so that they face each other across the axis X2 of the main body part 30 in the opening 28A connecting to the space 28 of the main body part 30. In the example shown in FIG. 3, two pairs of the detection devices 38 are arranged so that respective facing directions are orthogonal to each other. Therefore, the detection devices 38 are arranged at equal intervals in four places on a circumference of the opening 28A.

As a method for forming the green tire by using the tire forming apparatus 10 having the above structure, it is possible to cite a method including the following processes:

(1) a process of forming the band member T1 on the band drum 12,
(2) a process of forming the belt member T2 on the belt drum 14,
(3) a process of transferring the band member T1 formed on the band drum 12 to the shaping drum 16 by the band transfer 18,
(4) a process of transferring the belt member T2 formed on the belt drum 14 to the shaping drum 16 by the belt transfer 20, and
(5) a process of forming (shaping) the green tire by expanding the band member T1 in the radial direction to be assembled to the inner peripheral surface of the belt member T2 in the shaping drum 16. The green tire formed as described above is vulcanization-molded by using a tire mold in accordance with an ordinary method, thereby manufacturing a pneumatic tire. The above respective processes may be basically performed by using well-known methods.

The embodiment is characterized in that the belt member T2 on the belt drum 14 is inspected in the process of transferring the belt member T2 from the belt drum 14 to the shaping drum 16 by the belt transfer 20. This point will be described in detail below.

As shown in FIG. 2, the belt drum 14 in which the belt member T2 is formed on the outer peripheral surface thereof is on the same axis X2 as that of the belt transfer 20. The belt drum 14 is arranged at a position a prescribed distance apart from the end face 30A on the side facing the end face 30A where the detection devices 38 of the belt transfer 20 are installed. The belt transfer 20 is moved toward the belt drum 14 from this state as shown by the arrow A3 while keeping the positional relationship on the same axis X2.

Then, the measurement by the detection devices 38 is started at a point before the belt drum 14 is received in the space 28 of the belt transfer 20 as shown in FIG. 4. Specifically, the measurement is started by applying, for example, laser light L from the detection devices 38 at a point where the belt transfer 20 is moved and before the detection devices 38 thereof reach a position of the front end 14A of the belt drum 14.

The belt transfer 20 moves as it is along the axis X2 after the measurement is started by the detection devices 38, carrying out measurements to the rear end 14B of the belt drum 14 by the detection devices 38 as shown in FIG. 5. That is, the measurement is carried out by the detection devices 38, for example, by applying the laser light L until the detection devices 38 reach the position of the rear end 14B of the belt drum 14 and the measurement is completed at a point where the rear end 14B of the belt drum 14 is detected.

The belt transfer 20 moves as it is along the axis X2 after the measurement is completed. Then, the belt transfer 20 is stopped at a point where the belt drum 14 is received in the space 28 and the center in the axial direction of the belt drum 14 reaches a central position in the axial direction of the holding device 32 of the belt transfer 20 as shown in FIG. 6.

After that, the outer peripheral surface of the belt member T2 is held by operating the holding device 32 to move the respective holding members 32A in the diameter reducing direction (the inner side in the radial direction), and the belt transfer 20 receives the belt member T2 from the belt drum 14 by reduction in diameter of the belt drum 14.

The belt transfer 20 retraces its way while holding the belt member T2 after receiving the belt member T2, which allows the belt transfer 20 to be separated from the belt drum 14.

As described above, the belt transfer 20 moves toward the shaping drum 16 while keeping the positional relationship with respect to the shaping drum 16 on the same axis X2 until reaching the belt delivery position and stops there (see FIG. 1). The shaping drum 16 also moves to the belt delivery position as shown by the arrow A6. At this time, the shaping drum 16 is in a state where the band member T1 is already held on the outer periphery thereof. Accordingly, when the belt transfer 20 surrounds the outer periphery of the shaping drum 16, the belt member T2 is arranged on an outer periphery of the band member T1. The band member T1 is expanded outward in the radial direction in the above state to be assembled to the inner peripheral surface of the belt member T2. After that, the respective holding members 32A of the holding device 32 are moved to the diameter expanding direction to release the holding of the belt member T2 and deliver the belt member T2 to the shaping drum 16, thereby obtaining the green tire.

As the detection devices 38 are provided on one side in the axial direction of the main body part 30 in the belt transfer 20 as described above in the embodiment, the belt member T2 on the belt drum 14 can be detected by the detection devices 38 at the time of transferring the belt member T2 from the belt drum 14 to the shaping drum 16 by the belt transfer 20, specifically, during the operation of receiving the belt drum 14 having the belt member T2 into the belt transfer 20.

The dimension in the axial direction of the belt member T2 and the position of the belt member T2 on the belt drum 14 can be detected by detecting the belt member T2 during the receiving operation as described above; therefore, production efficiency is not impaired. It is also possible to detect positional displacement due to unexpected damage in equipment earlier. It is simple to install the detection devices 38 in the main body part 30 of the belt transfer 20; therefore, the inspection of the belt member T2 can be made with a compact structure and the detection device can be additionally installed to an existing transfer device, which allows inexpensive remodeling.

Additionally, the stands 40 can be replaced so as to correspond to the size (dimension in the axial direction) of the belt drum 14 by installing the detection devices 38 through the stands 40. That is, in order to carry out measurements over the entire belt drum 14 from the front end 14A to the rear end 14B during the receiving operation of the belt drum 14, it is necessary to set positions in the axial direction of the detection devices 38 so as to correspond to the dimension in the axial direction of the belt drum 14. According to the embodiment, it is possible to respond to belt drums 14 with various sizes by replacing the stands 40 to change the length of the columnar portions 40A.

Furthermore, the detection devices 38 are installed so as to face each other across the axis X2 at the opening 28A of the space 28 in the main body part 30; therefore, inspection of the tubular belt member T2 in the circumferential direction can be made with high accuracy while suppressing the number of the detection devices 38.

Although explanation has been made by citing the belt transfer 20 as an example in the above embodiment, it is also possible to adopt the same structure in the band transfer 18 to make inspection of the band member T1. The transfer device is not limited to the belt transfer or the band transfer.

That is, the transfer device may be the device for delivering a certain tire constituent member from a first drum for forming the tire constituent member to a second drum for performing a later forming process using the tire constituent member in the tire forming apparatus. That is, the transfer device that receives the tire constituent member from the first drum and delivers the tire constituent member to the second drum according to the embodiment can be applied to various transfer devices by utilizing the process of receiving. Here, the later forming process can be a process performed after the forming process in the first drum, not necessarily a process performed just after the forming process in the first drum. In the embodiment shown in FIG. 1 to FIG. 6, the above inspection structure is incorporated in the belt transfer 20 performing transfer of the tire constituent member between the belt drum 14 set as the first drum and the shaping drum 16 set as the second drum.

The tire constituent member to be inspected may either be the belt member or the band member. Concerning the belt member, the entire belt member formed on the belt drum may be inspected, or at least one of plural tire constituent members constituting the belt member can be an inspection target. For example, the maximum width belt ply, the outermost belt ply, plural sheets of belt plies including the above, and the tread rubber can be inspection targets.

Concerning the band member, the entire band member formed on the band drum may be inspected, or at least one of plural tire constituent members constituting the band member can be an inspection target. For example, the carcass ply wound around the inner liner can be an inspection target.

When detection is performed by utilizing the process of receiving the tire constituent member from the first drum, a detection item detected by the detection device may be the position of the tire constituent member on the first drum, the dimension in the axial direction of the tire constituent member or both of the position of the tire constituent member on the first drum and the dimension in the axial direction of the tire constituent member. When the position of the tire constituent member on the first drum is detected, the position of at least one end of the tire constituent member on the first drum may be detected, positions of both ends of the tire constituent member on the first drum may be detected, and the position of the center in the axial direction of the tire constituent member on the first drum may be detected by detecting the both ends. When the dimension in the axial direction of the tire constituent member is detected, both ends of the tire constituent member may be detected and a distance between the both ends may be calculated to thereby detect the dimension in the axial direction of the tire constituent member.

In the embodiment, the band transfer 18 and the belt transfer 20 are configured to move along the axes X1 and X2 so as to move between the band drum 12 and the shaping drum 16 as well as between the belt drum 14 and the shaping drum 16, respectively. However, the apparatus is not limited to the one in which the drums are fixed and the transfer devices are moved. It is also possible to fix the transfer devices and to move the drums along the axes instead of the above structure. In the case where the first drum is received in the space of the main body part of the transfer device from one side in the axial direction in the embodiment, at least one of the transfer device and the first drum may move along the axis, namely, the transfer device may be moved while the first drum is fixed, the first drum may be moved while the transfer device is fixed, and further, both are moved in directions coming close to each other.

Although the band drum 12, the band transfer 18, and one shaping drum 16A are arranged on the same axis X1, and the belt drum 14, the belt transfer 20, and the other shaping drum 16B are arranged on the same axis X2 in the above embodiment, the apparatus is not limited to this. All of the band drum, the belt drum, the shaping drums, the band transfer, and the belt transfer may be arranged on the same axis.

In the embodiments, all the first drum, the second drum, and the transfer devices do not have to be on the same axis, as long as the first drum and the transfer device are on the same axis at the time of receiving the tire constituent member from the first drum, and as long as the transfer device and the second drum are on the same axis at the time of delivering the tire constituent member from the transfer device to the second drum. For example, it is also preferable to adopt a structure in which the first drum and the second drum are arranged so that their axes are parallel to each other and the transfer device can move so as to be switched between a state where the transfer device is on the same axis as that of the first drum and a state where the transfer device is on the same axis as that of the second drum.

The first drum and the transfer device do not have to always be arranged on the same axis as described above, and it is sufficient that the transfer device is arranged on the same axis as that of the first drum when the transfer device receives the first drum. Additionally, the entire layout of the tire forming apparatus is not limited to the one shown in FIG. 1, and the embodiment can be applied to various layouts.

Some embodiments of the present invention have been explained above. These embodiments are cited as examples and do not intend to limit the scope of the invention. These embodiments may be achieved in other various manners, and various omissions, replacements, and alterations can be made without departing from the gist of the invention. These embodiments and modifications thereof may be included in the scope or the gist of the invention as well as included in the inventions described in claims and the range of equivalency.

What is claimed is:

1. A transfer device for transferring a tire constituent member from a first drum for forming the tire constituent member to a second drum for performing a later forming process using the tire constituent member in a tire forming apparatus, comprising:
a main body part having a space for receiving the first drum from one side in an axial direction in a state of being arranged on the same axis as that of the first drum in which the tire constituent member is formed on an outer peripheral surface;
a holding device provided so as to be able to hold the tire constituent member from an outer peripheral side in a state where the first drum is arranged in the space; and
a detection device installed on an end face on the one side in the axial direction of the main body part and detecting the tire constituent member formed on the first drum during a receiving operation of the first drum into the space.

2. The transfer device according to claim 1,
wherein the detection device detects at least one of a position of the tire constituent member on the first drum and a dimension in the axial direction of the tire constituent member.

3. The transfer device according to claim 1,
wherein the detection device is installed on the end face on the one side in the axial direction of the main body part through a stand extending in the axial direction.

4. The transfer device according to claim 1,
wherein the detection device carries out a measurement at least in a range from one end to the other end of the first drum in the axial direction of the first drum.

5. The transfer device according to claim 1,
wherein a plurality of detection devices are provided, and
the plural detection devices are provided in a pair or in plural pairs so that they face each other across the axis of the main body part in an opening connecting to the space of the main body part.

6. The transfer device according to claim 1,
wherein the transfer device is a belt transfer for transferring a tubular belt member from a belt drum for forming the belt member to a shaping drum for forming a green tire by using the belt member.

7. A tire forming apparatus comprising:
the transfer device according to claim 1;
a first drum for forming a tire constituent member; and
a second drum for performing a later forming process using the tire constituent member transferred by the transfer device.

8. A tire forming apparatus comprising:
the transfer device according to claim 2;
a first drum for forming a tire constituent member; and
a second drum for performing a later forming process using the tire constituent member transferred by the transfer device.

9. A tire forming apparatus comprising:
the transfer device according to claim 3;
a first drum for forming a tire constituent member; and
a second drum for performing a later forming process using the tire constituent member transferred by the transfer device.

10. A tire forming apparatus comprising:
the transfer device according to claim 4;
a first drum for forming a tire constituent member; and
a second drum for performing a later forming process using the tire constituent member transferred by the transfer device.

11. A tire forming apparatus comprising:
the transfer device according to claim 5;
a first drum for forming a tire constituent member; and
a second drum for performing a later forming process using the tire constituent member transferred by the transfer device.

12. A tire forming apparatus comprising:
the transfer device according to claim 6;
a belt drum for forming a tubular belt member; and
a shaping drum for forming a green tire using the belt member transferred by the transfer device.
